(19) United States
(12) Patent Application Publication
(10) Pub. No.: US 2020/0161862 A1
(43) Pub. Date: May 21, 2020

(54) STANDBY BATTERY-METER SOCKET ADAPTER WITH BATTERY PACK

(71) Applicant: BRIGGS & STRATTON CORPORATION, Wauwatosa, WI (US)

(72) Inventors: Joseph Rubens, Sussex, WI (US); Michael Miller, Lake Mills, WI (US); Brian Northway, Hartford, WI (US)

(73) Assignee: BRIGGS & STRATTON CORPORATION, Wauwatosa, WI (US)

(21) Appl. No.: 16/686,352

(22) Filed: Nov. 18, 2019

Related U.S. Application Data
(60) Provisional application No. 62/769,106, filed on Nov. 19, 2018.

(51) Int. Cl. H02J 3/14; H02J 9/08; H02J 9/06; H02J 3/32

(52) U.S. Cl. CPC H02J 3/14; H02J 9/08; H02J 7/1415; H02J 3/32; H02J 9/062

(57) ABSTRACT

An electrical system is operable to supply power from at least one of a primary power source or a standby power source to multiple electrical loads. The electrical system is configured to be provided between an electricity meter and a meter socket. The electrical system includes a housing, multiple contacts configured to be coupled with the meter socket, and a transfer switch for selectively connecting the primary power source or the standby power source to multiple electrical loads. The standby power source includes a battery bank including multiple storage batteries and a control module connected to the transfer switch.

### CROSS-REFERENCE TO RELATED APPLICATIONS

This application claims the benefit of U.S. Application No. 62/769,106, filed Nov. 19, 2018, which is incorporated herein by reference in its entirety.

### BACKGROUND

The present disclosure generally relates to the field of building electrical systems and more specifically to building electrical systems including utility power sources and a standby power source. Secondary power systems are generally configured to provide backup power to electrical loads in the event of a utility power failure. The transfer between the utility power source and the standby power source is facilitated by an automatic transfer switch.

Presently, the transfer of the power supply from the utility source to the standby power source is carried out by a transfer switch that is positioned in a location between an existing utility meter housing and a distribution panel. The existing utility meter housing includes a meter socket that receives an electricity meter for measuring the amount of electricity consumed by the home or business. In typical installations, the transfer switch is mounted at or near either the utility meter housing or at or near the distribution panel. The installation of the transfer switch is a complicated process, often including isolation of the ground wires from the neutral wires within the distribution panel (breaker box), and relocation of the neutral-ground bonding point. Electrical codes require that all neutrals in a house or building electrical system be bonded to ground at the closest point to the service entrance disconnect. Accordingly, when installing a transfer switch into an existing house between the utility meter housing and the distribution panel, an electrician will have to isolate the ground wires and neutral wires in the electrical distribution panel to their individual terminal strips and connect them to the corresponding ground and neutral terminals within the transfer switch panel. Once complete, the electrician will then be required to relocate the neutral-ground bonding point from its previous location (within the distribution panel) to the transfer switch panel as this is now the closest panel to the service entrance disconnect. This can be a time consuming process. The time required to install a transfer switch between the utility meter housing and the distribution panel can be between 2 and 4 hours and requires trained electricians, which can be costly for the home or business owner.

In the building electrical system described above that includes a standby power source, the standby power source is often a standby generator that includes an internal combustion engine powered by a fuel source, such as natural gas or propane. The fuel source is provided from a fuel storage location or tank or from a utility source. Such standby power sources that utilize a standby generator require connections to the fuel source, which increases the time and cost for installation.

The system of the present disclosure solves the above-identified problems present at installation while providing a standby power source for powering electrical systems within a home or building. The system of the present disclosure addresses the desire to provide a standby power source while eliminating the cost and complexity of installation.

### SUMMARY

One embodiment of the present disclosure includes an electrical system operable to supply power from at least one of a primary power source or a standby power source to one or more electrical loads. The electrical system is configured to be provided between an electricity meter and a meter socket. The electrical system includes a housing, multiple contacts configured to be coupled with the meter socket, and a transfer switch for selectively connecting the primary power source or the standby power source to the one or more electrical loads. The standby power source includes a battery bank including multiple storage batteries and a control module connected to the transfer switch.

Another exemplary embodiment of the present disclosure includes a meter socket adapter configured to allow switching between a utility power supply and a secondary power supply to provide power to an electrical load. The meter socket adapter is configured to be mounted between an electricity meter and a meter housing. The meter socket adapter includes a transfer switch for selectively coupling the utility power supply or the secondary power supply to the electrical load. The transfer switch is connected to a control module of the secondary power supply. The meter socket adapter also includes a load management controller.

The present disclosure relates to a transfer switch that can be plugged into an existing utility meter socket and thus electrically positioned between the meter socket and a distribution panel to allow switching between utility power and standby power. The plug-in transfer switch functions to transfer the power supplied to a home between the metered utility power source and the secondary power source upon loss of power from the utility power source. In accordance with the present disclosure, a standby power source is provided that includes a series of storage batteries included in a battery bank. The battery bank is connected to a control module, which in turn is connected to a transfer switch contained within the meter socket adapter. When utility power is interrupted, the transfer switch contained within the meter socket adapter switches to the standby power source such that the standby power source provides electric power to operate the electric loads contained within a home or business. The control module includes a power inverter circuit that transforms the DC power from the battery bank to an AC power supply that can be used to power the loads within the home.

When the utility power supply returns, the control module disconnects the standby power source from the loads within the home and monitors the remaining charge on the battery bank. A battery charging circuit contained within the control module recharges the battery bank such that the battery bank will be available for the supply of electric power upon the next utility interruption. The control module of the present disclosure can also selectively connect the standby power source to the loads within the home during times of peak power consumption or peak energy costs. In this way, the standby power source can increase the capacity of the utility by utilizing the stored power supply on the battery bank at desired times.

The standby power source of the present disclosure interfaces directly with the meter socket adapter and can be installed without the need for any fuel line connections. In alternate, exemplary embodiments, additional power sources, such as a photovoltaic system or a supplemental generator can be connected to the control module to either increase the amount of power from the standby power source or to recharge the batteries contained within the standby power source.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view illustrating the mounting of the transfer switch with a meter socket adapter to an existing utility meter socket between a standby generator and a distribution panel;

FIG. 2 is a side view showing the mounting of the meter socket adapter to the utility meter socket;

FIG. 3 is a perspective view of the meter socket adapter;

FIG. 4 is a schematic illustration of the standby power source of the present disclosure; and

FIG. 5 is a block diagram illustrating the operational components of the standby power system of the present disclosure.

### DETAILED DESCRIPTION

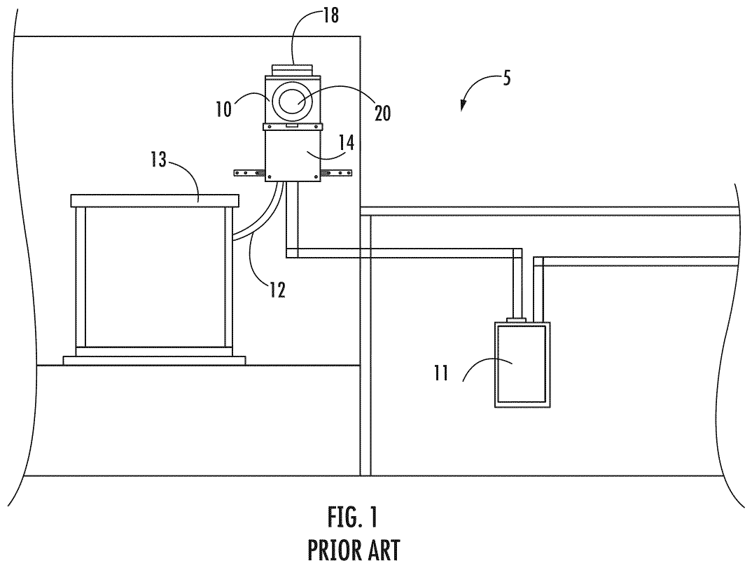

FIG. 1 illustrates a prior art electrical system 5 for a building (e.g., a home electrical system). Electrical system 5 includes an electric meter housing 18 that encloses a contact block that is electrically coupled to an off-site utility power source (not shown) and configured to provide power from the off-site utility source through an electricity meter 20 to a distribution panel 11. Distribution panel 11 (e.g., a circuit breaker box, a fuse box, etc.) is configured to route electrical power to electrical loads (not specifically shown in FIG. 1) in the building. Electrical system 5 also includes a standby generator 13 connected to a fuel source for providing electrical power to distribution panel 11 instead of (or potentially in addition to) the utility power provided through the meter housing 18. For example, the standby generator 13 may be configured to provide power to distribution panel 11 through a transfer switch in the event of a utility power failure.

The electrical system 5 includes a meter socket adapter 10 that is positioned between the meter housing 18 and the distribution panel 11. The meter socket adapter 10 is shown and described in U.S. Pat. No. 9,620,305 and is available from Briggs & Stratton Corporation under the Direct Power™ name. The adapter 10 includes an internal transfer switch controller and contacts to control the supply of power to the electric loads from either the utility or generator 13. The meter socket adapter 10 is hard wired to the standby generator 13 through a cable 12. The factory installed cable 12 can be a 25-foot, 50-foot or any other desired length cable that connects to the standby generator 13 or disconnect box in a known manner. The cable 12 enters into the outer housing 14 to provide power to a set of internal contacts that allows the transfer switch components of the meter socket adapter 10 to switch to power from the generator 13 when the utility-side power is interrupted. The outer housing 14 is preferably made of metal, such as steel or aluminum. However, other materials, such as a durable composite, are contemplated as being a viable alternative.

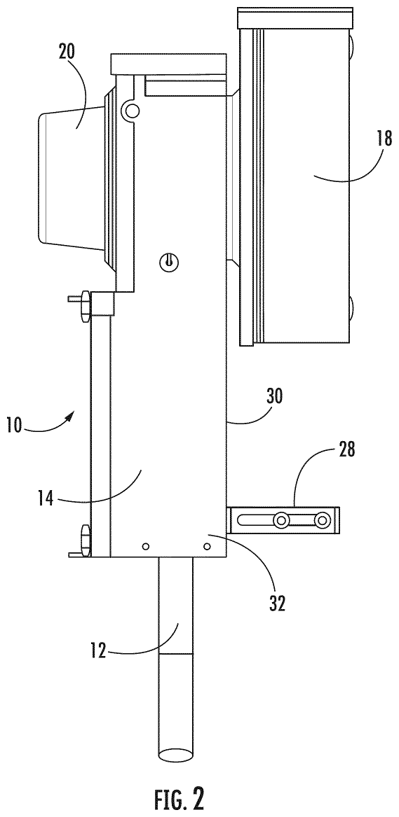

As can be seen in FIG. 2, the meter socket adapter 10 is plugged into a meter socket formed as part of the conventional meter housing 18. The meter housing 18 is conventionally mounted on the exterior of a home or on the interior of a building. The meter housing 18 typically receives an existing electricity meter 20 through the interaction between contact blades on the back surface of the electricity meter 20 and receiving jaws formed within the meter socket. The meter socket adapter 10 of the present disclosure is positioned between the meter housing 18 and the electricity meter 20.

In addition to the transfer switch controller, the meter socket adapter 10 also includes load management controls contained inside the outer housing 14. The load management controls communicate to load relays that are located in series with electric loads at the home or business. Wired or wireless communications can be used to activate the load relays to provide load shedding capabilities.

The load management controller contained within the outer housing 14 functions to selectively shed loads from the power distribution system and subsequently reconnect the loads to the power distribution system depending upon the amount of power drawn by the loads and the power available from the standby power source. The details of the load management control board can vary depending upon the particular power distribution system. The details of one exemplary load management controller and its method of operation are set forth in U.S. Pat. No. 8,415,830, the disclosure of which is incorporated herein by reference. However, other types of load management systems and methods of operation are contemplated as being within the scope of the present disclosure. The load management controller is contained within the housing such that both the transfer switch and the load management components required to selectively shed/reconnect loads within the home serviced by the generator can be installed as a single device contained within the housing.

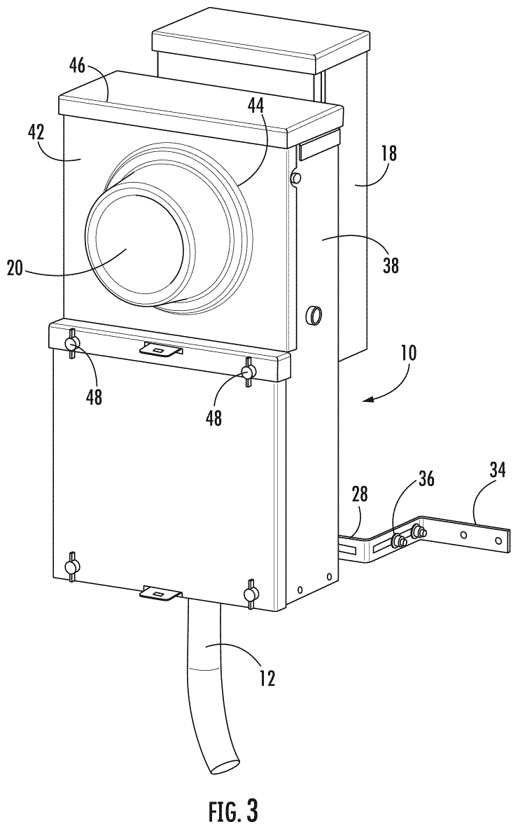

FIG. 3 illustrates the meter socket adapter 10 securely mounted to the utility meter housing 18. Typically, the utility meter housing 18 will be mounted to a wall of a building or home. The utility meter housing 18 can be mounted to either an exterior wall of a building or, in some instances, can be mounted inside a building. As discussed previously, the utility meter housing 18 typically receives the electricity meter 20. However, when the meter socket adapter 10 is utilized, the electricity meter 20 is received within the meter socket adapter 10 while the meter socket adapter 10 is received within the meter socket of the meter housing 18. A support bracket 28 is attached to a back surface 30 of the outer housing 14. Although not required, the support bracket 28 is typically attached to the same wall that supports the meter housing 18. The support bracket 28 provides support for the bottom end 32 of the meter socket adapter 10. The support bracket 28 includes a pair of extending horizontal mounting portions 34 that can be securely attached to a wall surface. A pair of adjustment bolts allow the depth of the support bracket 28 to be adjusted depending upon the thickness of the meter housing 18.

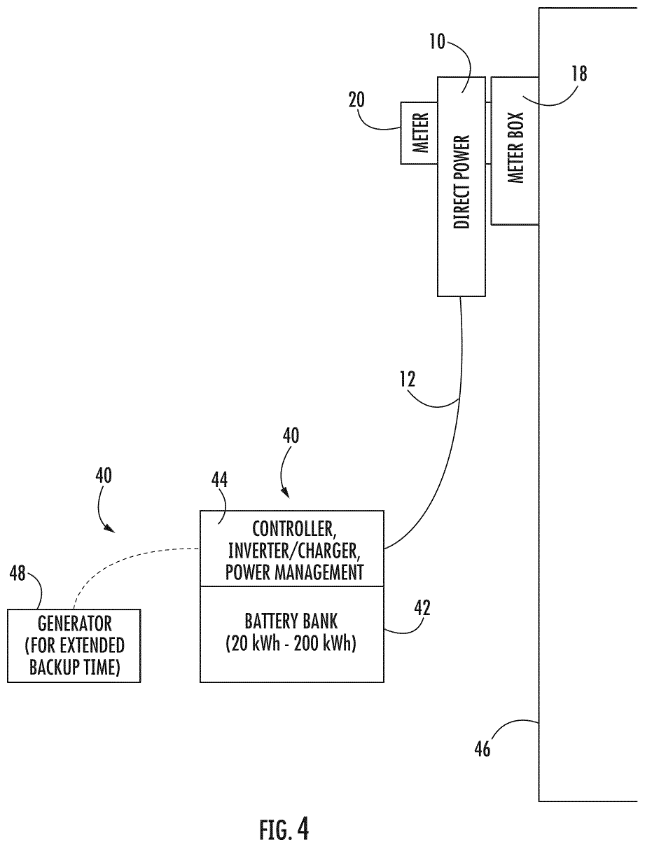

FIG. 4 illustrates an exemplary embodiment in accordance with the present disclosure in which the standby generator 13 shown in FIG. 1 is replaced by an alternate standby power source 40. The standby power source 40 replaces the generator 13 and is connected to the meter socket adapter 10 by the same cable 12 shown in FIG. 1. In the embodiment illustrated, the standby power source 40 includes a battery bank 42 and control module 44. The battery bank 42 and control module 44 replace the standby generator and provides a source of electric power to operate the electric loads contained within the home or building 46. The battery bank 42 is illustrated as having a capacity of between 20 kWh and 200 kWh. However, the size and capacity of the battery bank 42 can vary outside of this range depending upon the power requirements for the home or business including the standby power source 40. In the embodiment shown in FIG. 4, a supplemental generator 48 could be connected to the control module 44 to provide additional standby power. The generator 48 could be either a standby generator, such as shown by reference numeral 13 in FIG. 1, or portable generator that is plugged into the control module 44 as will be described in greater detail below.

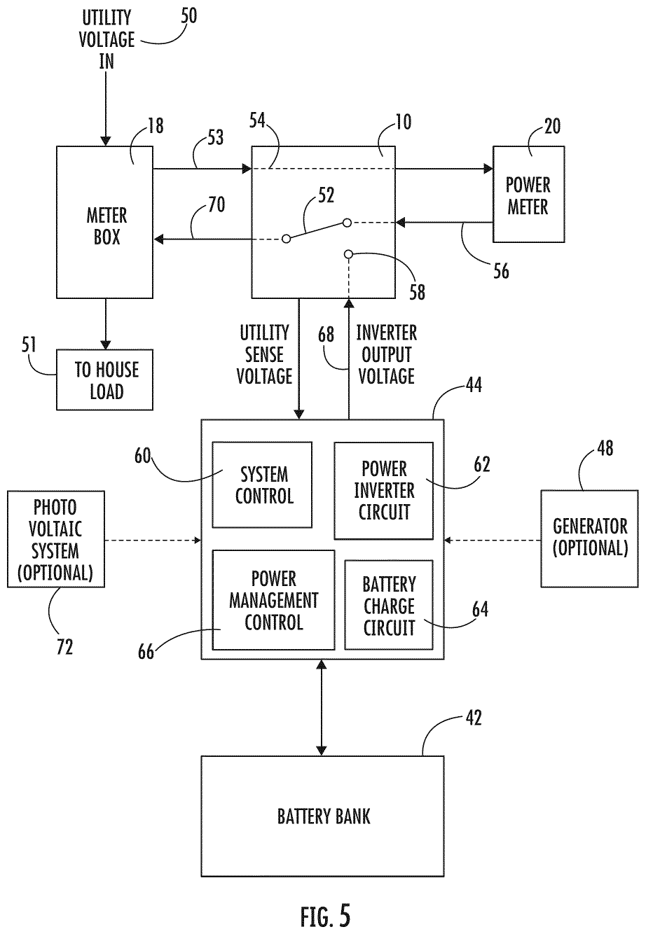

FIG. 5 provides a system diagram of a standby power source 40 constructed in accordance with the present disclosure. In the embodiment shown in FIG. 5, a supply of utility voltage 50 is received at the meter box 18 as is conventional. The meter box 18, in turn, is connected to a home or small business to power electric loads within the home, as shown by reference numeral 51. As described previously, the standby power source includes the meter socket adapter 10 that is directly connected to the meter box 18 through the inlet line 53. The meter socket adapter 10 includes a transfer switch 52 that is movable between first and second positions as will be described below. As shown in FIG. 5, a direct connection 54 allows power from the meter box 18 to travel through the meter 20. The opposite power connection 56 from the meter 20 flows through the transfer switch 52 and back to the meter box 18 when the transfer switch 52 is in the position shown in FIG. 5. The position of the transfer switch 52 in FIG. 5 is the position when utility power is present or when the system desires to have the utility power drive the loads 51 contained within the house. The power from the utility flows through the meter box 18 and to the loads 51 in the home.

If the transfer switch 52 is moved to a second position in which the switch is in contact with the secondary internal terminal 58, the power connection from the utility is interrupted such that the supply of power from the utility no longer flows through the power meter 20 and to the loads 51.

As shown in FIG. 5, the control module 44 includes a system controller 60, a power inverter circuit 62, a battery charging circuit 64 and a power management controller 66. Although each of these control circuits are shown within a common control module 44, it should be understood that one or more of the individual controls 60, 62, 64 or 66 could be either removed from the control module 44 and located elsewhere in the system or eliminated. The operation of each of the separate controls will be described in greater detail below.

In the embodiment shown in FIG. 5, a battery bank 42 is connected to the control module 44. The battery bank 42 preferably includes a series of individual batteries linked together either in a series or parallel configuration, or both. In one embodiment of the present disclosure, the battery bank 42 is a 96 kWh battery pack which is able to power the electric loads 51 within a home for between 8-12 hours of full operation. The individual batteries within the battery bank 42 can be various types of batteries, such as but not limited to lithium ion battery packs. Further, it is contemplated that the number and size of the individual batteries that make up the battery bank 42 could be initially selected or later modified by the homeowner depending upon the back-up power needs for the home. As an illustrative example, if the homeowner decides that the current size of the battery bank 42 is not sufficient for the home or if the power demands of the home have changed since installation, the homeowner can add additional batteries to the battery bank 42 to increase both the output power and the standby supply time.

The control module 44 includes a power inverter circuit 62 that is able to convert the DC output voltage from the battery bank 42 to an AC output. The AC output from the power inverter circuit 62 is supplied to the terminal 58 in the meter socket adapter 10 through the output line 68. When the transfer switch 52 is switched to the secondary position and is thus in contact with the terminal 58, the inverter output voltage on line 68 is supplied to the meter box through the output line 70. The secondary power supplied from the battery bank 42 is then directed to the house loads 51 such that the house loads 51 can be run from the stored power supply from the battery bank 42. The system control 60 is used to monitor the charge on the battery bank 42 and control operating parameters of the power inverter circuit 62 in a well-known, conventional manner.

When the utility power supply is interrupted or absent, stored electric power from the battery bank 42 is supplied to power the house loads 51 as discussed above. However, it should be understood that the supply of electric power from the battery bank 42 is limited. Thus, after the utility power supply returns, the transfer switch 52 is moved back to the position shown in FIG. 5 such that utility power is supplied to the house loads 51.

At this time, the battery charging circuit 64 determines the stored charge on the battery bank 42 and functions to recharge the series of batteries contained within the battery bank 42. The battery charging circuit 64 can typically utilize the utility voltage 50 to recharge the battery bank 42. The system shown in FIG. 5 can also include other alternate charging sources. In the embodiment shown in FIG. 5, a photovoltaic system 72 is connected to the control module 44 such that the battery charging circuit 64 can utilize the photovoltaic system 72 to recharge the battery bank 42. As described previously, the system can also include a generator 48 that can either supplement the power supplied from the battery bank 42 or can be used to recharge the battery bank 42 as desired. The generator 48 can be a standby generator or a gas-powered back up generator depending upon the requirements of the homeowner. The generator 48 can be operated by the homeowner to either recharge the battery bank 42 when the utility power supply is no longer present or can be utilized to provide power directly to the house loads 51 in combination with the battery bank 42. The use of a generator 48 allows for the secondary power source 40 shown in the present disclosure to provide power to the house loads 51 for an extended period of time should the utility power supply 50 be interrupted for a period longer than can be supplied by the battery bank 42.

The control module 44 further includes a power management control 66. The power management control 66 can be included either in the control module 44 or within the meter socket adapter 10. In each case, the power management control 66 can send signals to load management modules that are associated with high power consuming loads within the home. In this manner, the power management controller 66 can selectively shed high power consuming loads either when the battery bank 42 is becoming depleted or as desired to extend the time at which the battery bank 42 can power the house loads 51. In this manner, the control module 44 is able to shed loads as desired to extend the period of time that the battery bank 42 can supply and power the house loads 51.

As described above, the battery bank 42 can be used to supply power to house loads 51 during times in which the utility power supply 50 is not available, such as during storms, power outages or at other times when the utility power supply is interrupted. In addition, the battery bank 42 can be utilized at other times that are controlled either by the homeowner or by the utility. As an illustrative example, during times at which the demand for power faced by the utility is high, the utility can send control signals out to the control module 44 that cause the transfer switch 52 to switch to the secondary power supply from the battery bank 42. In this manner, the utility can increase capacity by utilizing the stored power on the battery banks 42 of individual homeowners. Such control could be utilized to avoid brown outs.

In another contemplated embodiment, the battery bank 42 can be connected to the house loads 51 during times at which energy is at the peak cost. In this manner, the homeowner would be able to reduce power consumption from the utility at times when the cost of power from the utility is at a peak value. Switching would not only reduce the power consumption for the homeowner but would also be a benefit to the utility by reducing peak loads.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electrical system operable to supply power from at least one of a primary power source or a standby power source to one or more electrical loads, the electrical system configured to be provided between an electricity meter and a meter socket, comprising:
a housing;
a plurality of contacts configured to be coupled with the meter socket; and
a transfer switch for selectively connecting the primary power source or the standby power source to the one or more electrical loads,
wherein the standby power source comprises a battery bank comprising one or more storage batteries and a control module connected to the transfer switch.

2. The electrical system of claim 1, wherein the control module comprises a system controller operable to control the position of the transfer switch to selectively connect the standby power source to the one or more electrical loads.

3. The electrical system of claim 1, wherein the control module comprises a power inverter to convert direct current (DC) power from the battery bank to alternating current (AC) power to supply power to the one or more electrical loads.

4. The electrical system of claim 1, wherein the control module comprises a battery charging circuit operable to recharge the one or more storage batteries of the battery bank.

5. The electrical system of claim 4, wherein the battery charging circuit recharges the one or more storage batteries of the battery bank using a utility voltage from the primary power source or the standby power source.

6. The electrical system of claim 1, further comprising a load management controller located in the housing.

7. The electrical system of claim 6, wherein the load management controller monitors the load on the standby power source and selectively disconnects one or more of the electrical loads from the standby power source based upon the monitored load on the standby power source.

8. The electrical system of claim 6, wherein the load management controller communicates via wired or wireless communications to load relays, the load relays connected in series with the one or more electrical loads, to provide load-shedding capabilities.

9. The electrical system of claim 1, further comprising a photovoltaic system connected to the control module, wherein the photovoltaic system is utilized to recharge the one or more storage batteries of the battery bank.

10. The electrical system of claim 1, further comprising a generator connected to the control module, wherein the generator provides an additional amount of power from the standby power source or provides power to recharge the one or more storage batteries of the standby power source.

11. The electrical system of claim 1, wherein the control module further comprises a power management controller, the power management controller operable to signal to the load management controller to disconnect one or more electrical loads based on a remaining charge of the battery bank.

12. A meter socket adapter configured to allow switching between a utility power supply and a secondary power supply to provide power to an electrical load, the meter socket adapter configured to be mounted between an electricity meter and a meter housing, the meter socket adapter comprising:
a transfer switch for selectively coupling the utility power supply or the secondary power supply to the electrical load, wherein the transfer switch is connected to a control module of the secondary power supply; and
a load management controller.

13. The meter socket adapter of claim 12, wherein the load management controller monitors the electrical load on the secondary power supply and selectively disconnects the electrical load from the secondary power supply based upon the monitored load on the secondary power supply.

14. The meter socket adapter of claim 12, wherein the load management controller communicates via wired or wireless communications to load relays, the load relays connected in series with the electrical load, to provide load-shedding capabilities.

15. The meter socket adapter of claim 12, wherein the transfer switch is movable between a first position and a second position and wherein the position of the transfer switch is controlled by the load management controller.

16. The meter socket adapter of claim 15, wherein the first position couples the transfer switch to the utility power supply to power the electrical load from the utility power supply and the second position couples the transfer switch to the secondary power supply to power the electrical load from the secondary power supply.

17. The meter socket adapter of claim 16, wherein the control module is operable to receive a signal to change the position of the transfer switch to the second position to use the secondary power supply during a high demand for utility power.

18. The meter socket adapter of claim 12, wherein the secondary power supply directly interfaces with the meter socket adapter and is installed without the use of fuel line connections.

19. The meter socket adapter of claim 12, wherein the secondary power supply comprises a battery bank including a plurality of batteries and the control module connected to the transfer switch.

20. The meter socket adapter of claim 19, wherein the control module is connected to a generator, wherein the generator provides an additional amount of power from the secondary power supply or provides power to recharge the plurality of batteries of the secondary power supply.
